(19) United States
(12) Patent Application Publication
(10) Pub. No.: US 2017/0190035 A1
(43) Pub. Date: Jul. 6, 2017

(54) TOOL DEVICE FOR CONNECTING A PLASTIC TUBE TO A FITTING

(71) Applicant: REHAU AG + CO, Rehau (DE)

(72) Inventors: SVEN CHRISTOPH, Weisendorf (DE); RICHARD SAPPER, Schwabach (DE); EHRENFRIED BONHAG, Schwabach (DE); DANIEL WOLTER, Durmentingen (DE)

(21) Appl. No.: 15/313,165

(22) PCT Filed: May 30, 2015
(86) PCT No.: PCT/EP2015/001101

§ 371 Date: Nov. 22, 2016

(30) Foreign Application Priority Data
Jun. 3, 2014 (DE) 10 2014 107 752.0

(51) Int. Cl. B25B 27/10

(52) U.S. Cl. CPC B25B 27/10

(57) ABSTRACT

The invention relates to a tool device (1) for connecting a plastic tube or a metal/plastic composite tube to a fitting with a sliding or pressing sleeve, comprising a housing (2); an expansion device (3) for expanding the ends of the plastic tube or the metal/plastic composite tube; a sliding device (4) for sliding on the sliding sleeve or a pressing device for pressing on the pressing sleeve; and a drive element (5) which can be operated mechanically and which can be actuated in a switchable manner in order to drive the expansion device (3) or in order to drive the sliding or pressing device (4). The expansion device (3) and the sliding or pressing device (4) are connected to the housing (2), and the drive element (5) can be switched between driving the expansion device (3) and driving the sliding or pressing device (4) by rotating the housing (2) relative to the drive element (5). The invention additionally relates to the use of such a tool device (1) for connecting a plastic tube or a metal/plastic composite tube to a fitting with a sliding or pressing sleeve.

The present invention relates to a tool device for connecting a plastic pipe or a metal-plastic composite pipe to a fitting comprising a sliding or pressing sleeve, comprising a housing, a flaring device for flaring the ends of the plastic pipe or the metal-plastic composite pipe, a pushing device for pushing on the sliding sleeve, or a pressing device for pressing on the pressing sleeve, as well as a machine-operable drive element, which may be actuated in a change-over manner to drive the flaring device or the pushing or pressing device, wherein the flaring device and the pushing or pressing device are connected to the housing and are at least partly accommodated in the housing.

Such a tool device is known from DE 10 2008 051 284 B3. In the device described therein, the drive element has only one working piston, which may be selectively moved to drive a flaring device, on the one hand, or a sliding or pressing device, on the other hand, via a change-over device in the form of a change-over valve in two mutually diametrically opposite directions of movement to drive a flaring device. However, this tool device has the disadvantage that the change-over device requires an operating element, such as a switch, a rotary knob or the like, on the tool device, which, for example, may trigger random faulty operation by overturning the tool device.

Accordingly, the object of the present invention is to provide a tool device for connecting a plastic pipe or a metal-plastic composite pipe to a fitting with a sliding or pressing sleeve which overcomes the disadvantages of the prior art. In particular, the tool device according to the invention is not to be susceptible to accidental incorrect operation and should be capable of being intuitively operated by the installer. Furthermore, the present invention relates to the use of such a tool device for connecting a plastic pipe or a metal-plastic composite pipe to a fitting with a sliding or pressing sleeve.

This and other objects are achieved by a tool device according to claim 1 or by the use according to claim 10. Preferred embodiments of the tool device of the present invention are described in the dependent claims.

According to the present invention, it has been recognized that a change-over between the two operating modes of the tool device may be carried out most easily for the installer if this conversion is effected by directly rotating the tool device itself. For the installer, it is then intuitively recognizable in which mode of operation the tool device is currently located, since the device which is currently being controlled, i.e. either the flaring device on the one hand or a sliding or pressing device on the other hand, points in a specific direction relative to the drive element. This also applies if the modes of operation have been changed over (for example, if the tool device is overturned), so that accidental faulty operation is unlikely since the change-over of the mode of operation may be easily detected by the installer.

Accordingly, the present invention relates to the provision of a connector for connecting a plastic pipe or a metal-plastic composite pipe to a fitting with a sliding or pressing sleeve, wherein the tool device according to the invention comprises a housing; a flaring device for flaring the ends of the plastic pipe or the metal-plastic compound pipe; a pushing device for pushing on the sliding sleeve or a pressing device for pressing on the pressing sleeve; and a machine-driven drive element that may be actuated in a change-over manner to drive the flaring device or to drive the sliding or pressing device, wherein the flaring device and the sliding or pressing device are connected to the housing and are at least partly accommodated in the housing. According to the invention, the tool device is characterized in that the change-over of the drive element between driving the flaring device and driving the sliding or pressing device may be effected by rotating the housing relative to the drive element. In addition, the present invention relates to the use of a tool device according to the invention as claimed in one of the preceding claims for connecting a plastic pipe or a metal-plastic composite pipe to a fitting with a sliding or pressing sleeve.

As used herein, the term “machine-driven drive element” means an element with which the actual drive (e.g. a hydraulic pump or the like) is attached to the tool device according to the invention, and by means of which an operative connection between the flaring device or the sliding or pressing device on the one hand and the actual drive is effected.

With respect to the tool device according to the invention, it may prove to be helpful if the flaring device comprises a first piston-cylinder unit with a first working piston, which may be controlled by a first valve, while the sliding or pressing device comprises a second piston-cylinder unit with a second working piston, which is controllable via a second valve. Such a configuration with two separate piston-cylinder units allows a compact design of the tool device according to the invention and a simple and effective way to control the flaring device and the sliding or pressing device separately from one another. Furthermore, in the case of such a configuration, the respective piston does not first have to be returned to its starting position when the mode of operation of the tool device is changed. Thus, the tool device no longer has to traverse its entire travel path. This saves significant time when connecting a pipe end to a fitting.

It has thus proved to be particularly advantageous when, in a first rotational position of the housing relative to the drive element, the first valve is open and the second valve is closed, while, in a second rotational position of the housing relative to the drive element, the first valve is closed and the second valve is open. In this connection, it is particularly preferred if the opening and closing of the first valve and of the second valve takes place via a common shaft which is preferably designed as an eccentric shaft. In a particularly preferred embodiment of the present invention, the common shaft, which in this case is also preferably designed as an eccentric shaft, remains positionally stable relative to the drive element during rotation of the housing.

It has proved to be advantageous if a first piston axis of the first piston-cylinder unit runs parallel to a second piston axis of the second piston-cylinder unit, while the flaring device and the sliding or pressing device are arranged next to one another and offset with respect to one another. This achieves a more compact design of the tool device according to the invention, so that the tool device according to the invention requires little space in order to be used.

Furthermore, it may be advantageous if the two piston-cylinder units have different cylinder diameters. As a result, the force required for operating the flaring device, on the one hand, and the sliding device or the pressing device, on the other hand, may be specifically adjusted by the selection of the cylinder diameters of the respective piston-cylinder unit. In practice, it has proven to be particularly advantageous if the piston-cylinder unit of the flaring device has a smaller cylinder diameter than the piston-cylinder unit of the sliding device or the pressing device.

In this case, the movement of the drive element preferably takes place in a translatory or rotary manner. The drive element is preferably operated translatively and mechanically. In this case, the mechanical movement of the drive element preferably takes place hydraulically. The hydraulic device required for this purpose may be connected to the tool device according to the invention, for example by screwing on or snapping on. In a first rotational position of the housing relative to the drive element, the drive from the hydraulic device is used to operate the piston-cylinder unit of the flaring device. The piston of this piston- cylinder unit is used to flare one end of the plastic pipe or the metal-plastic composite pipe. In a second rotational position of the housing relative to the drive element, the drive from the hydraulic device is used to operate the piston-cylinder unit of the sliding device or the pressing device.

Furthermore, the present invention relates to the use of the tool device according to the invention for connecting a plastic pipe or a metal-plastic composite pipe to a fitting with a sliding or pressing sleeve.

In the following, the present invention will be explained in detail with reference to the embodiment shown in the figures. The present invention is explained in detail with reference to a tool device according to the invention for a pipe connection to a fitting with a sliding sleeve. However, it is to be understood that the present invention is also equally suitable for the use of a tool device for connecting a pipe to a fitting with a pressing sleeve using a corresponding pressing device.

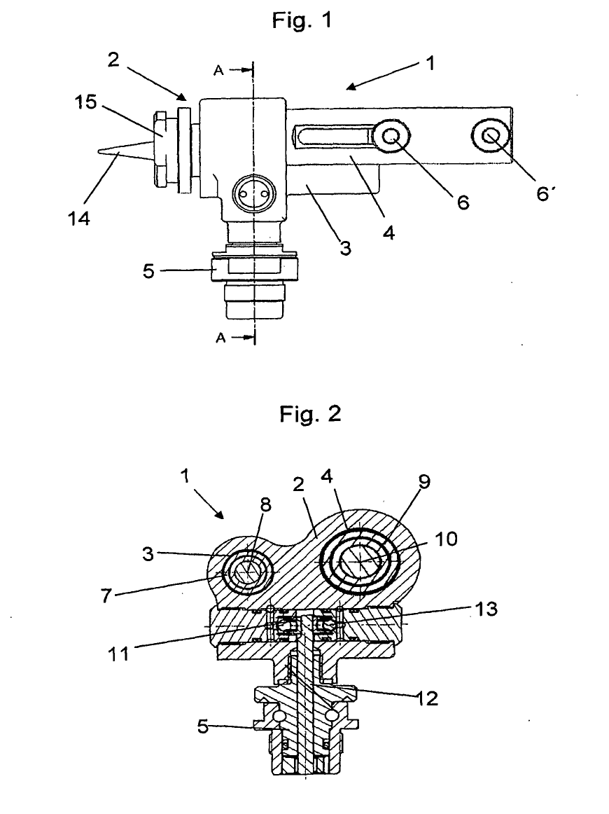

FIG. 1 shows a side view of a tool device according to an embodiment of the present invention with a pressing yoke.

FIG. 2 shows a sectional view of the tool device shown in FIG. 1 along the line A-A in FIG. 1 looking in the direction of the arrow.

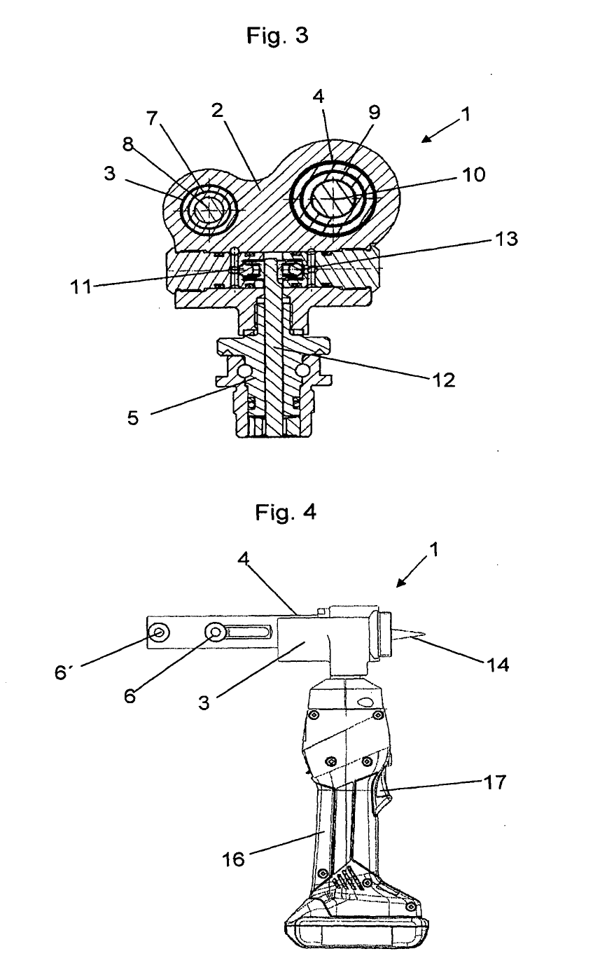

FIG. 3 shows a sectional view of the tool device shown in FIG. 2 after a rotation through 180°.

FIG. 4 shows a side view in which a tool device according to the invention is mounted on a drive device with a hydraulic drive.

The figures show an embodiment of a tool device 1 according to the invention for connecting a plastic pipe or a metal-plastic composite pipe to a fitting with a sliding or pressing sleeve. The tool device 1 according to the invention comprises a housing 2, a flaring device 3 for flaring the ends of the plastic pipe or the metal- plastic composite pipe, a sliding device 4 for pushing on the sliding sleeve, and a machine-operable drive element 5. The flaring device 3 and the sliding device 4 are each connected to the housing 2 and partly accommodated in the housing 2.

By rotating the housing 2 relative to the machine-operable drive element 5, the tool device according to the invention may be changed over between the two operating modes: in a first rotational position of the housing 2 relative to the drive element 5, for example in the rotational position shown in FIG. 3, while the sliding device 4 is activated following a rotational operation through 180° of the housing 2 relative to the drive element 5. Both rotational positions are recognizable to the user by the fact that the housing 2 engages in the drive element 5. In alternative embodiments, the two rotational positions, in each of which the flaring device 3 or sliding device 4 may be controlled, may extend over a circular sector of up to approximately 60°, preferably approximately 30°. Thus, the tool device 1 according to the invention is then optionally set up for operation of the flaring device 3 to flare the ends of a plastic pipe or a metal-plastic composite pipe or to operate the sliding device 4 in order to push on the sliding sleeve. Two sliding elements may each be fastened to the sliding device 4 by means of fastening bolts 6, 6′ shown in FIG. 1. Such sliding elements are known, for example, from DE 20 2008 010 080 U1, the disclosure of which is referred to with reference to the design and mode of operation of sliding elements.

FIG. 2 shows a sectional view of the embodiment of the tool device 1 according to the invention shown in FIG. 1 along the line A-A in FIG. 1, viewed in the direction of the arrow, wherein the fastening bolts 6, 6′ are removed. The first piston-cylinder unit 7 of the flaring device 3 with the associated first piston axis 8, as well as a second piston-cylinder unit 9 of the sliding device 4 with the associated second piston axis 10, may be seen here. The two piston axes 8, 10 extend parallel to one another, but do not coincide. In addition, the two piston-cylinder units 7, 9 are offset and displaced relative to one another. The relative position of the flaring device 3 and of the sliding device 4 relative to one another is described in detail in DE 20 2012 104 763 U1, to which reference is hereby explicitly made. A first valve 11, by means of which the flaring device 3 may be activated and which is released by the eccentric shaft 12 in FIG. 2, is located in the housing 2. Hydraulic fluid may be conveyed into the first piston-cylinder unit 7 through the first valve 11 so that the flaring device 3 may be operated in this rotational position of the housing 2 relative to the drive element 5. In contrast, the second valve 13, by means of which the sliding device 4 may be controlled, is closed due to the relative position of the eccentric shaft 12. The working piston of the piston/cylinder unit 7 is guided out of the cylinder at one end and is designed as a flaring mandrel 14 (see FIG. 1). A flaring head or expansion head (not shown) may be connected to the flaring device 3 via a connecting element 15. Such a flaring head is known, for example, from DE 20 2010 004 948 U1, the disclosure of which is hereby incorporated by reference as regards the design and mode of operation of the flaring head.

FIG. 3 shows a sectional representation of the embodiment of the tool device 1 according to the invention shown in FIG. 1 and FIG. 2 following rotation of the housing 2 relative to the drive element 5 through 180°. The first valve 11 is closed and the second valve 13 is opened by the position of the eccentric shaft 12, while the second valve 13 is open. Hydraulic fluid may flow into the second piston-cylinder unit 9 through the second valve 13 so that the sliding device 4 may be operated in this rotational position of the housing 2 relative to the drive element 5. During operation of the sliding device 4, the piston of the piston-cylinder unit 9 drives a movable sliding element in the direction of a further sliding element. The two sliding elements are only indicated in FIG. 5 by their fastening bolts 6, 6′. The sliding element indicated by the fastening bolt 6 is pressed against the sliding element by the piston of the second piston-cylinder unit 9, indicated by the fastening bolt 6′, which is held in a position-stable manner on the sliding device 4. As a result of the movement of the one sliding element against the other sliding element, a sliding sleeve is pushed over a pipe end flared by the flaring device 3, a plastic pipe or a metal-plastic composite pipe into which a fitting is inserted to form a non-releasable connection. The inside diameter of the first piston-cylinder unit 7 is less than the diameter of the second piston-cylinder unit 9.

In the first rotational position of the housing 2 relative to the drive element 5, in which the first valve 11 is opened, when a hydraulic pump accommodated in a hydraulic tool 16 (FIG. 5) is activated through a switch 17, the piston of the flaring device 3 is moved away from the tool device 1 in the direction of the end of the flaring device 3. The mandrel-shaped end 14 of the piston then penetrates into the flaring head, as a result of which the pipe end pushed onto the flaring head is flared. In this rotational position of the housing 2 relative to the drive element 5, the flaring mandrel 14 of the flaring device 3 points in the direction of the switch 17. This makes it immediately apparent to the installer operating the tool device 1 according to the invention, that the tool device 1 according to the invention is switched to the “flaring” mode of operation, i.e. the flaring device 3 may be operated by actuating the switch 17.

In the second rotational position of the housing 2 relative to the drive element 5, in which the second valve 13 is opened, the piston of the sliding device 4 is moved when the switch 17 is actuated. As a result, a sliding sleeve, which has been pushed into the fitting that has been introduced via the flared pipe end, is pushed onto the pipe end with the fitting inserted in order to form a non-detachable connection. In this rotational position of the housing 2, the sliding device 4 of the tool device 1 according to the invention is rotated relative to the drive element 5 through 180° in the direction of the switch 16, and thus again shows intuitively to the installer working with the tool device 1 according to the invention that the tool device 1 according to the invention is set to the “pressing” mode, i.e. the sliding device 4 may be operated by actuating the switch 17.

1.-10. (canceled)

11. A tool device for connecting a plastic pipe or a metal-plastic composite pipe to a fitting with a sliding or pressing sleeve, comprising:
a housing;
a flaring device to flare the ends of the plastic pipe or the metal-plastic compound pipe;
a sliding device for pushing on the sliding sleeve or a pressing device for pressing on the pressing sleeve; and
a machine-operable drive element that is operable to be actuated in a change-over manner to drive the flaring device or to drive the sliding or pressing device;
wherein the flaring device and the sliding or pressing device are connected to the housing and are at least partly accommodated in the housing;
wherein the drive element is operable to be changed over between the drive of the flaring device and the drive of the sliding or pressing device by rotating the housing relative to the drive element.

12. The tool device according to claim 11, wherein the flaring device includes a first piston-cylinder unit with a first working piston, which is controllable by a first valve, and the sliding or pressing device includes a second piston-cylinder unit with a second working piston, which is controllable by a second valve.

13. The tool device according to claim 12, wherein, while in a first rotational position of the housing relative to the drive element, the first valve is opened and the second valve is closed, and, while in a second rotational position of the housing relative to the drive element, the first valve is closed and the second valve is opened.

14. The tool device according to claim 13, wherein the first valve and the second valve are opened and closed by a common shaft.

15. The tool device according to claim 14, wherein the common shaft is configured as an eccentric shaft.

16. The tool device according to claim 14, wherein the common shaft remains position-stable relative to the drive element during rotation of the housing.

17. The tool device according to claim 12, wherein an axis of the first piston-cylinder unit runs parallel to an axis of the second piston-cylinder unit, while the flaring device and the sliding or pressing device are arranged next to one another and offset relative to one another.

18. The tool device according to claim 17, wherein the two piston cylinder units have different cylinder diameters.

19. The tool device according to claim 18, wherein the piston-cylinder unit of the flaring device has a smaller cylinder diameter than the piston-cylinder unit of the sliding or pressing device.

20. A method for connecting a plastic pipe or a metal-plastic composite pipe to a fitting with a sliding or pressing sleeve, comprising:
providing a tool device;
wherein the tool devices comprises:
a housing;
a flaring device to flare the ends of the plastic pipe or the metal-plastic compound pipe;
a sliding device for pushing on the sliding sleeve or a pressing device for pressing on the pressing sleeve; and
a machine-operable drive element that is operable to be actuated in a change-over manner to drive the flaring device or to drive the sliding or pressing device;
wherein the flaring device and the sliding or pressing device are connected to the housing and are at least partly accommodated in the housing;
wherein the drive element is operable to be changed over between the drive of the flaring device and the drive of the sliding or pressing device by rotating the housing relative to the drive element.
